(19) United States
(12) Patent Application Publication
(10) Pub. No.: US 2008/0217906 A1
(43) Pub. Date: Sep. 11, 2008

(54) GAME TICKET

(76) Inventor: Neil Ellis, St. Catherines (CA)

Correspondence Address: PEARNE & GORDON LLP, 1801 EAST 9TH STREET, SUITE 1200, CLEVELAND, OH, 44114-3108, US

(21) Appl. No.: 12/031,902

(22) Filed: Feb. 15, 2008

Related U.S. Application Data
(60) Provisional application No. 60/890,257, filed on Feb. 16, 2007.
(60) Provisional application No. 60/893,643, filed on Mar. 8, 2007.

(51) Int. Cl. B42D 15/00

(52) U.S. Cl. 283/72

(57) ABSTRACT

A method for printing a plurality of randomized tickets that include a play combination area for a game of chance is provided. One of the steps of this method is to provide data to a printer. The data includes a digital press sheet that includes the plurality of randomized tickets where each randomized ticket includes an identification image. The digital press sheet includes a plurality of different identification images. Another step is to print the digital press sheet onto a substrate where the printer does not perform a further randomization of the plurality of randomized tickets. In another example, a blockout area is provided for a breakopen ticket to provide a printable area on an inner surface of the breakopen portion. In another example, a method is provided to digitally divide a plurality of randomized tickets into groups of relatively equal sizes where approximately equal payout values are provided within the plurality of randomized tickets of each group. In another example, a host structure is provided that includes a plurality of removable randomized tickets where the host structure includes its own seal card for use with its removable randomized tickets.

### CROSS-REFERENCE TO RELATED APPLICATIONS

This application claims the benefit of U.S. Provisional Application No. 60/890,257, filed Feb. 16, 2007, the entire disclosure of which is hereby incorporated herein by reference. This application also claims the benefit of U.S. Provisional Application No. 60/893,643, filed Mar. 8, 2007, the entire disclosure of which is hereby incorporated herein by reference.

### BACKGROUND OF THE INVENTION

The present invention relates to tickets for a game of chance, and more particularly to tickets for a game of chance, amusement, promotional, or advertisement purposes.

Jar tickets are folded tickets for a game of chance. They are small, paper, folded and banded tickets that are purchased by a player for a predetermined amount. They are typically stored in a jar or other receptacle prior to purchase by a player. They can be produced and purchased in a single ticket format or bundled in groups, such as groups of 2, 3, 4, 5 or 10's. Tickets can be stapled or glued together when in bundles. The jar ticket is traditionally a single ply folded and banded paper ticket, featuring symbols, letters or numerals. Tickets can be sold to a player in bundles or mounted on a board. Players reveal the symbols by ripping or breaking open the ticket from a banded bond.

After the player opens the banded section to reveal the symbol(s), they compare the ticket to a “flare” or display card to determine if they have a winning or losing ticket. The flare, which is enclosed with each set of game tickets, illustrates the pre-determined winning symbol(s), letter(s) or number(s), their associated prize amounts and the quantity of each contained in the set. The flare card also specifies the game name, cost per ticket to players, the manufacturer's form number and set serial number.

Jar tickets are often not used in the charitable bingo games and state lottery games because their small size and non-sequential packaging makes it difficult to track and sell them.

Breakopen tickets are constructed of two plies of material connected together by adhesive with perforated windows on one side that breakopen when the ticket is played. Breakopen tickets often have multiple play combinations on a single ticket. Breakopen tickets are often used in the charitable bingo games and state lottery games. The size and construction of a breakopen ticket is more conducive to handling and tracking of product during its pre-sale and sale than that of a jar ticket. Traditionally breakopen tickets are packaged in sets of 100 with an elastic band around them for easy counting.

Traditional gaming tickets are manufactured in a sheet-fed printing plant using multiple printing plates of static images to produce press sheets. Normally, there are a limited number of press sheets produced to make a volume of tickets because each press sheet requires a plurality of plates and additional set-ups and wash-ups on the printing press. This process can be expensive, which may make it uneconomical to produce small quantities of tickets or completely unique sets of tickets. In the traditional process, the use of serial numbers is important to differentiate a ticket from one set from a ticket from a different set, primarily because each set of tickets in a specific product are exactly the same but shuffled into a different order. In some instances, gaming tickets make use of a variable print technology that depends on the use of databases at the time of printing to randomize the product. This method of manufacture is still not utilized to its full capacity because of the high cost of variable printing and the low quality of the printed images. Variable data printing is where databases of symbols must be used to populate the print stream during the process of printing. Thus, the database must be accessible to a printer at the time of printing. Population of a game ticket with various play combinations happens at the time of actual printing via the printer's accessing of the database, so customer pre-approval of a game set cannot be achieved.

One disadvantage of the prior art manufacturing processes is that some type of randomization process must be performed on the tickets. Sometimes, a mathematician would have to determine where to cut various sheets of tickets to randomize the winnings between different groups. In other cases, shuffling could be performed but this can take a substantial amount of time. Hand-feeding also could be used where a person puts winning tickets generally in the middle of various packs of tickets. However, it would be more desirable to have a process that creates an equal distribution of winnings between groups and also can provide a more consistent distribution within a group of tickets. One current problem is that if a set of tickets are sold at a store and an owner realizes that not many winners have been played; the owner could have an incentive to purchase the remaining tickets himself. Thus, it would be desirable to have a distribution that can more evenly randomize or distribute winning tickets between different groups (e.g. different store locations) or within a group (e.g. one store location) where the distribution can be controlled.

Jar tickets, breakopen tickets, and other tickets are sold in venues such as Bingo Halls, Corner Stores, Bars, Clubs, lotteries, etc. Currently, the products are produced by a number of different manufacturers all following the same size, and play styles. The market follows traditional formats and is not very progressive in new innovative product styles. More popular in the industry is innovative artwork, play styles and payouts. Crossovers between vertical markets such as “scratch-off” on “Breakopens” and Jars have been limited to a small patch of scratch-off on the “common”, static image side of a “Breakopen” for security checks only. The usage of scratch-off inks in the sealed areas of these products has not been a feasible option due to lack of creative ideas in the industry and technology limitations.

One of the disadvantages with current games is that currently, if a game set has 500 tickets in a set of tickets for a game, the current industry standard is to print one “common” identification panel for the ticket or to print one common “window” side or breakopen side exactly the same within the set of 500. The “common” side identifies the game and/or shows the different combinations for winning. Current industry standards are based on static printing such that if there are differences in the common side, a purchaser can identify winning tickets by comparing differences between the common sides of tickets that may have occurred during the printing process. Thus, irregularities in the printing process could occur that affect the common sides of the tickets which can allow a purchaser to identify winning tickets. Repeated irregularities, for example, due to a stray mark on the printing plate, may allow a player to identify winning tickets. For example, all winning tickets may have an unplanned mark that allows winning tickets to be readily distinguished from non-winning tickets. Others in the prior art have produced packs with varying identification panels but each variant is part of a different deal or different game.

With each set of tickets produced, a Flare card is enclosed with each set of game tickets which illustrates the pre-determined winning symbol(s), winning letter(s) or number(s), their associated prize amounts, and the quantity of each contained in the set. The flare card also specifies the game name, cost per ticket to players, the manufacturers form number, and set serial number. The Flare card can also illustrate pre-determined winning symbol(s), letter(s), or number(s), for the scratch tab win if applicable.

A “Seal” card can be enclosed with each set of game tickets which provides additional winnings or “play value” to individual “Breakopen” or Jar tickets. The “Seal” is normally an additional or bonus prize that is concealed underneath a scratch-off ink, a foil, or a perforated tab area. This bonus card would be the only current product that utilizes technology from one vertical market to the other. For example, a Jar Game could have a Seal card that has its prize concealed underneath a “Breakopen” tab or a scratch off area. The seal card is printed in considerably less volume and is included as one seal card per set of tickets.

As these tickets are a form of gambling, state and local governments in the United States have a considerable amount of regulation in place to govern where tickets may be sold, how much they can be sold for, and how much of their revenue must be given out as prize money.

Tickets with this innovation can be sold in any number of the markets. During fiscal year 2003 U.S. lottery sales totaled $44.9 billion (US), while Canadian sales reached $9.0 billion (Can). Worldwide lottery sales were more than $126 billion in 1998. In addition, the instant lottery ticket industry is a recession-resistant industry. A manufacturer that can complement traditional gaming products with increased playability features and more economical production techniques will certainly have an improved position within the lottery industry.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a method for printing a plurality of randomized tickets that include a play combination area for a game of chance is provided. One of the steps of this method is to provide data to a printer. The data includes a digital press sheet that includes the plurality of randomized tickets where each randomized ticket includes an identification image. The digital press sheet includes a plurality of different identification images. Another step is to print the digital press sheet onto a substrate where the printer does not perform a further randomization of the plurality of randomized tickets.

In accordance with another aspect of the present invention, a method for printing a plurality of randomized tickets that include a play combination area for a game of chance is provided. One of the steps of this method is to provide a breakopen portion that has an outer surface and an inner surface. The breakopen portion is provided on one of a first ply and a second ply for revealing a play combination where the play combination is printed on one of the first ply and the second ply by a printer based on data that includes the plurality of randomized tickets where the printer does not perform a further randomization of the plurality of tickets. Another step in this method is to print a blockout area on the outer surface of the breakopen portion where the blockout area is configured to meet or exceed a predetermined opacity. Another step in this method is to provide a printable area on the inner surface of the breakopen portion.

In accordance with another aspect of the present invention, a method for providing a plurality of randomized tickets that include a play combination area for a game of chance is provided. One of the steps of this method is to provide data that includes the plurality of randomized tickets, where the data includes the play combination area and a customized payout scheme defining a number of winners for a specified amount of randomized tickets. Another step in this method is to digitally divide the data into groups of relatively equal sizes where approximately equal payout values are provided within the plurality of randomized tickets of each group. Another step in this method is to form at least one digital press sheet from the groups of data that include the plurality of randomized tickets and the play combination area.

In accordance with another aspect of the present invention, a method for printing a plurality of randomized tickets that include a play combination area for a game of chance is provided. One of the steps of this method is to provide data that includes the play combination area and a customized payout scheme defining a number of winners for a specified amount of randomized tickets to form the plurality of randomized tickets on at least one digital press sheet. Another step of this method is to print the digital press sheet onto a substrate, to print a plurality of winning symbols in the play combination area on a first portion of each of the plurality of randomized tickets, and to print a plurality of game symbols on each of the plurality of randomized tickets on a second portion where the plurality of winning symbols are configured to be compared to the plurality of game symbols to determine if a specific ticket is a winner. Another step in this method is to print at least one of a game form number, game serial number, or a card number on the plurality of randomized tickets for verification purposes. Another step in this method is to fold the substrate to form a first ply and a second ply.

In accordance with another aspect of the present invention, a set of a plurality of tickets for a game of chance is provided that includes a plurality of host structures, a plurality of removable randomized tickets, and a seal card. The removable randomized tickets are located on each of the plurality of host structures where the plurality of removable randomized tickets each includes a play combination area. The seal card is located on each of the plurality of host structures that is configured to reveal a payout scenario for the plurality of removable randomized tickets. The plurality of removable randomized tickets each includes one or more breakopen portions or windows.

In accordance with another aspect of the present invention, a method for printing a plurality of randomized tickets that include a play combination area for a game of chance is provided. One of the steps of this method is to provide a customized guaranteed payout scheme for the set of the plurality of tickets where the customized guaranteed payout scheme defines a number of winners for a specified amount of randomized tickets. Another step is to provide data that includes the play combination area, the customized guaranteed payout scheme, and at least one additional payout scenario, to form the plurality of randomized tickets on at least one digital press sheet. Another step is to print the at least one digital press sheet onto a substrate. Another step is to print a plurality of winning symbols in the play combination area on a first portion of each of the plurality of randomized tickets where the plurality of winning symbols are configured to determine if a specific ticket is a winner. Another step is to provide a possible payout that is paid for each of the plurality of tickets that includes the at least one additional payout scenario.

### BRIEF DESCRIPTION OF THE SEVERAL VIEWS OF THE DRAWINGS

The foregoing and other aspects of the present invention will become apparent to those skilled in the art to which the present invention relates upon reading the following description with reference to the accompanying drawings, in which:

FIG. 1 shows a perspective view of a first example game ticket;

FIG. 2 shows front and rear elevation views of the game ticket of FIG. 1;

FIG. 3A shows outer sides of second example attached break-open tickets;

FIG. 3B shows inner sides of the attached break-open ticket of FIG. 3A;

FIG. 4 shows a partial front view before and after a break-open ticket of FIG. 3A is opened;

FIG. 5 shows a front view of a plurality of identification panels for use with a single game;

FIG. 6 shows a front view of a third example ticket with a color area provided for identification purposes;

FIG. 7 shows a front view of a ticket in the prior art with a color background provided for identification purposes;

FIG. 8 shows a digital press sheet;

FIG. 9 shows a front side, a rear side, a left inner side, and a right inner side of a fourth example ticket;

FIG. 10 shows a portion of a fifth example ticket;

FIG. 11 shows a front view of an example host structure and sixth example ticket; and

FIG. 12 shows a front view of the host structure of FIG. 11 with one of the tickets removed from the host structure.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

One example of the subject invention is a product for the gaming industry and a method for printing a plurality of randomized tickets that include a play combination area for a game of chance. Specifically, in one example, the subject invention is for the “Breakopen” and “Jar” ticket industries.

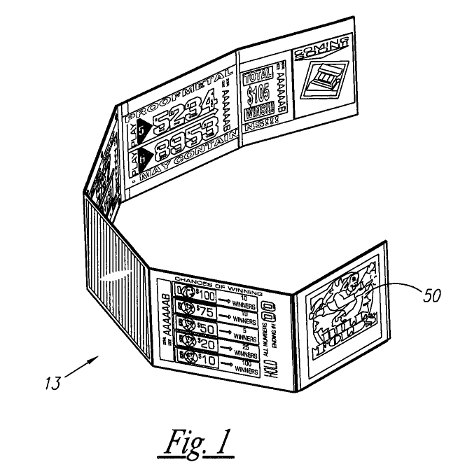

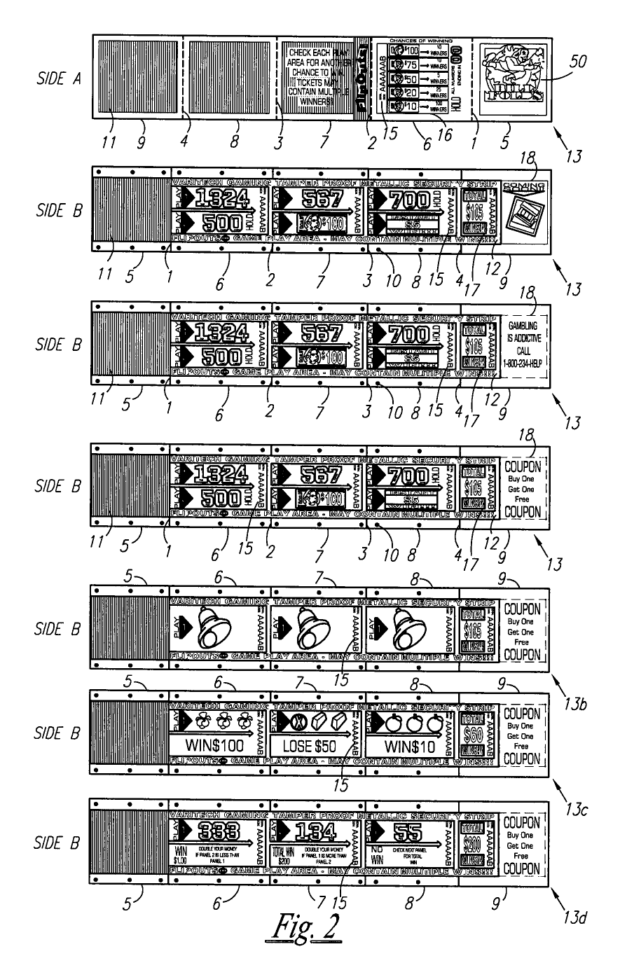

Turning to the shown example of FIG. 1 and FIG. 2, the printing of a “Jar” ticket is shown. FIG. 1 shows a perspective view of a first example ticket. The ticket 13 in this example is a substantially unfolded ticket 13. The ticket 13 can be held in the unopened position by glue. The ticket 13 can also be held in the unopened position by stapling or crimping, for example, crimping along one or more of the folded ticket's 13 edges. The ticket 13 can also be held in the unopened position by a band wrapped around the folded ticket.

FIG. 2 shows an example of the ticket 13 of FIG. 1 where the ticket 13 includes two sides, an “A” side and a “B” side. Side A is the rear side of the ticket 13 and side B is the front side of the ticket 13. In an embodiment, the ticket 13 is constructed from a single-play material, such as paper or card stock, and includes printing on both sides of the single-ply material. In an embodiment, the ticket 13 forms an elongated strip wherein the strip's length exceeds its height. The height of the ticket 13 can be any desired height, for example, 3.75 inches, 3 inches, 2.5 inches, 2 inches, 1.5 inches, 1 inch, 0.75 inches, or 0.5 inches. A series of folds along fold lines 1, 2, 3, 4 divide the ticket into several panels 5, 6, 7, 8, 9. The ticket 13 is shown in an unfolded or completely opened position

Panel 5 is an identification panel. Printed on side A of the identification panel 5 is the game's name and form number. For example, the game shown in FIG. 1 is called “BILL FOLDS” and has form number 12345. The form number corresponds to the name of the game, the number of tickets in the game and the game's payout. The form number functions as a model number.

Panels 6, 7 and 8 are game panels. Printed on side B of the game panels 6, 7, 8 are play combinations that can include symbols, characters, images, numbers or other markings that provide winning or losing game plays. Game plays can also include an instant win indication, as can be seen in game panel 8. In FIG. 2, each game panel, 6, 7 and 8 includes two play combinations or one play combination and one instant win indication, for a total of six plays on the ticket 13. A ticket 13 can include any number of game panels, for example, one, two, or three or more game panels. A ticket 13 can include any number of game plays per game panel, such as one game play per panel, more than one game play per panel, or combinations of single and multiple game plays per panel on one ticket 13.

A code, for example a serial number or alphabetic serial code 15 is printed on each game panel 6, 7 and 8. The code could include both letters and numbers, such as a hexadecimal code. The alphabetic serial code 15 is a series of letters that uniquely identifies a particular deal of a game. For example, the same form number may be repeatedly printed and played, that is, dealt, over a given period of time. However each repetition has a unique alphabetic serial code 15 so that only winning tickets for that deal, bearing the correct alphabetic serial code 15, can be used to collect a prize. By printing the alphabetic serial code on each game panel 6, 7, and 8, a winning ticket can be accidentally or intentionally ripped, for example, ripped along a fold line 1, 2, 3, 4, and a winning portion of the ticket 13 submitted to claim a prize.

Printed on side A of game panel 6 is the alphabetic serial code 15, which is visible when the ticket 13 is folded up along fold lines 1, 2, 3, 4 as described further below. Also printed on side A of game panel 6 are the game's payout scheme and winning symbols 16.

Printed on side B of panel 9 is a winner/loser and total win indication 17. Further printed on side B of panel 9 is an advertisement, coupon, or other message, such as a message 18 regarding a charity. For example, panel 9 can include a warning message about compulsive gambling and/or information about sources of help for compulsive gamblers. Panel 9 can include one or both of the advertisement, coupon, or other message 18 and the winner/loser and total win indication 17. In an embodiment, panel 9 is not provided and the ticket 13 includes an identification panel 5 and one or more game panels 6, 7, 8. In an embodiment, the advertisement, coupon, or other message extends inward from an end of the ticket 13 to at least 0.25 inches from the end.

The ticket 13 is folded up prior to playing to form an unopened position and held shut by glue, for example, fugative glue 10. The glue 10 may be placed on the ticket 13 in dots, lines or other configurations. The ticket 13 may also be held shut by other methods including crimping, stapling and banding. The ticket 13 is folded up by panel 9 being folded over panel 8 along fold line 4. Then panels 9 and 8 are folded over panel 7 along fold line 3. Then panels 9, 8 and 7 are folded over panel 6 along fold line 2. Then panel 5 is folded over panels 6, 7, 8 and 9 along fold line 1 and glued to side A of panel 7. When the ticket 13 is completely folded up prior to playing, side A of panels 5 and 6 are visible, along with part of side A of panel 7. Panel 5 is not as wide as panels 6, 7, 8 and 9 and, therefore, does not completely cover panel 7 when folded over and glued to panel 7.

The ticket is played by unfolding the ticket in a manner opposite from the folding process described above. The ticket 13 includes a blockout area 11, which can be formed by printing one or more colors on top of each other to increase the opacity of a portion of the ticket 13 and reduce the ability of light to pass through the folded ticket 13.

In an embodiment, one or more panels of the ticket 13 include printing 12 that defines a perimeter area within a panel. For example, the perimeter area 12 can surround the play combinations within a game panel. The perimeter area 12 is printed with a metallic ultra violet (UV) ink and/or coating that acts as a security strip, and which will stop the glue 10 from bleeding into the play area and hinder the ability for duplicating of the ticket 13 on a photocopier. Wording can be applied to the UV metallic ink security strip to ensure that a ripped ticket is re-assembled in a correct order.

In addition to the embodiment described above, FIG. 2 shows a ticket 13b having a single play combination of three symbols spread over several game panels 6, 7, 8.

FIG. 2 further shows a ticket 13c having a progressive/digressive play scheme in which successive game panels provide increased or decreased winnings. Game panel 6 shows a play combination that results in a $100 win. However, game panel 7 shows a play combination that results in a $50 loss. Game panel 8 shows a play combination that results in a $10 win. A total win of $60 is displayed in panel 9, which is the sum of the winnings and losses provided by all of the game panels 6, 7, 8.

FIG. 2 further shows a ticket 13d having a progressive play scheme in which a condition provided in one game panel must be met by another game panel to result in increased winnings. For example, game panel 6 provides that a $100 win will be doubled if the play combination of game panel 7 is less than the play combination of game panel 6. Because the play combination of game panel 7 is less than the play combination of game panel 6, game panel 7 provides an indication that the total winnings have been doubled to $200. Game panel 7 provides that the $200 win will be doubled if the play combination of game panel 8 is more than the play combination of game panel 7. Because the play combination of game panel 8 is less than the play combination of game panel 7, game panel 8 provides an indication that there is no increase in winnings. Panel 9 provides a total win indication of $200. In an embodiment, game panels 6, 7, 8 include conditions that, if met, result in decreased winnings. In an embodiment, if the condition for a game panel 6, 7, 8 is not met by another game panel, then there is a win of $0 for said game panel 6, 7, 8.

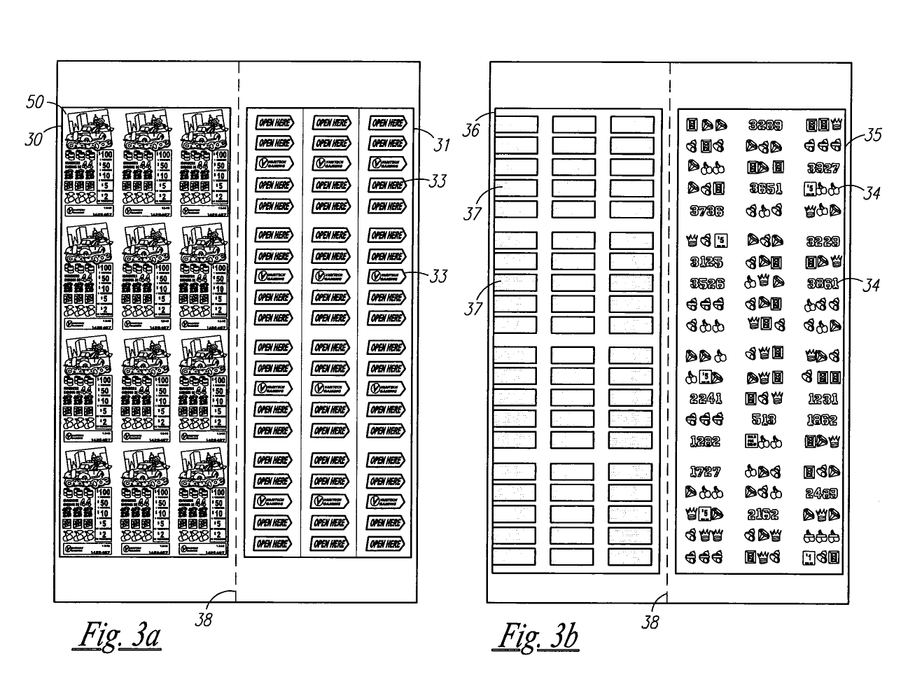

Turning to the shown example of FIG. 3A and FIG. 3B, the printing of a second example of a “Breakopen” ticket is shown. FIG. 3A and FIG. 3B show twelve attached breakopen tickets, three across and four down, printed on a substrate as discussed below, but prior to folding and gluing the tickets, cutting the breakopen portions or windows, and separating individual tickets. FIG. 3A shows outer sides of the tickets prior to folding. FIG. 3B shows inner sides of the tickets prior to folding. The terms “outer side” refer to the sides of ticket that are accessible to a player prior playing the game of chance, that is, prior to opening any breakopen windows. The terms “inner side” refer to the sides of the ticket that are not accessible to a player prior to playing the game of chance.

The tickets include a front outer side 30 and a rear outer side 31. The front outer side 30 includes information printed thereon, such as a name of the game, payout information and a game serial number. The rear outer side 31 includes a plurality of breakopen portions or windows 33 for revealing corresponding game play combinations 34 that are printed on front inner side 35. In an embodiment, play combinations are printed on the rear inner side 36. The breakopen portions or windows 33 can be formed by cutting several lines of weakness into the ticket, so that the breakopen portion 33 is partially or completely separated from the ticket when played.

The rear inner side 36 can include a plurality of blockout areas 37 printed on the breakopen portions 33. In an embodiment, the blockout areas 37 are created with a single UV ink, such as a metallic UV ink, or multiple combinations of UV inks, one of which may be a metallic UV ink. Metallic ultraviolet inks can be used to create security patterns on tickets and areas exhibiting metallic effects. In another example embodiment, an ultraviolet coating is applied over the top of the play combination area, such as the game play combinations 34. The ultraviolet coating can be applied in a pattern so that when the ticket is tilted and light reflects off the coating, the pattern is recognizable. The ultraviolet coating provides additional security as it makes a winning ticket more difficult for a person to illegally make. For example, an ultraviolet coating can prevent a person from simply cutting and pasting different portions from different tickets together because the pattern of the ultraviolet coating will not be continuous unless the symbol with the coating was genuine. The ultraviolet coating can be applied to any of the types of tickets described throughout the specification. This system will eliminate possible cheating by photocopying game symbols and recombining the winning combinations and pasting them back into a game ticket window. In another embodiment, glitter is mixed with a UV coating to create a sparkling coating on specific areas of the ticket.

Glue can be applied to the rear inner side 36 of the tickets, the attached breakopen tickets are folded along fold line 38, and the front inner side 35 is glued to the rear inner side 36. The attached tickets are then separated into individual single tickets.

In another embodiment, a verification symbol, word, or serial number, or any combination of these (referred to as a “patch”) can be printed in the window portion of the ticket and then covering it with a scratch off ink, foil or coating. Breakopen tickets can include scratch-off areas (not shown) having a layer of removable, scratch-off material. A scratch-off layer could be provided on a breakopen ticket for security purposes. For example, a scratch-off layer could conceal a winning ticket verification. The patch will be marked not to be scratched by the purchaser. The seller can then scratch off the patch to verify that the ticket is a winner. A scratch-off layer could be provided on the front inner side 35 of the ticket, which could be revealed by opening a breakopen portion.

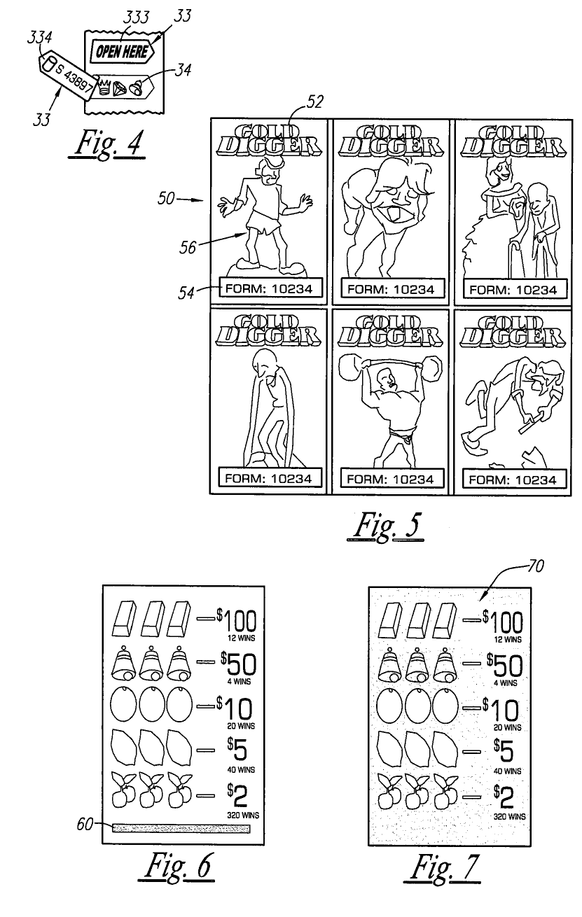

In yet another embodiment, seen in FIG. 4, a portion of a second example ticket is shown that includes multiple break-open portions where a security blockout area is printed on the visible window side of the ticket, such as an outer surface 333 of the breakopen portion 33. The top portion of FIG. 4 shows a portion of a break-open ticket before the break-open ticket is actuated or opened. The bottom portion of FIG. 4 shows a portion of a break-open ticket after the break-open ticket is actuated or opened. The blockout area leaves an inner surface 334 of the breakopen portion 33, substantially white and available for printing information. The outer surface 333 can also be considered the exterior of the breakopen portion 33. A serial number, or other identifying information, can be printed on at least part of the inner surface 334 of the breakopen portion 33. A play combination can also be printed on the inner surface 334 of the breakopen portion. This differs from the embodiment previously discussed where the blockout area was on the inner surface of the window. Thus, by providing the blockout area on the outer surface 333, an additional area is created that can be used for printing a second set of play combinations, an advertisement, or other uses of printable area as the additional area is not accessible until after the ticket is opened. This then allows for the additional printing of gaming insignia digitally on the inside windows or other messages and or advertising. The printing of the blockout area can use the properties of multiple coats of at least one ultraviolet ink, water-base ink, or solvent base ink to create a blockout area that is configured to meet or exceeds a predetermined opacity, such as a “500 lumin” blockout opacity of a currently available security paperboard. Solvent base ink has proven during testing to be the best choice though other inks could still be used. Thus, in one example, a breakout portion with an outer surface and an inner surface can be provided where the breakopen portion is provided on one of a first ply and a second ply for revealing a play combination. The play combination is printed on one of the first ply and the second ply by a printer. The printer can use data that includes the plurality of randomized tickets where the printer does not perform a further randomization of the plurality of tickets and the blockout area is printed on the outer surface of the breakopen portion while the play combination is printed on the inner surface of the breakopen portion.

An example of multiple “common” sides for one game is shown in FIG. 5. The ability to have multiple images on the “common” side and/or “window” of a break-out portion provides increased curiosity and play value. Customers may be more likely to buy more tickets because they like a certain image, they think a certain image is good luck for them, or because they want to collect all the different images. For example, a plurality of different identification images can be printed on a digital press sheet for each game of chance where the printer does not perform a further randomization of the plurality of tickets. In FIG. 5, six different common panel images are provided on tickets within a single game set. A purchaser may choose to buy more tickets of one image because they feel it is their lucky ticket. Turning to the shown example of FIG. 5, the printing of multiple “common” side or “window” side images within one game set are shown. The example of FIG. 5 includes a plurality of different identification panels 50 that are configured for use in the same game of chance. The identification panels 50 can further include a game title 52, a form number 54, and an identification image 56. The game title 52 can be provided for identifying the game. The form number 54 can be provided to also identify the exact game of chance that the ticket corresponds to, as there may be more than one game of chance in operation using the same game title 52. An identification image 56 for each randomized ticket can be varied between each of the identification panels 50 within a deal or set of a game. In other examples, each of the components of the identification panel 50, other than the form number, can be varied within one single deal of a game. For example, varying identification panels 50 of the jar tickets of FIG. 1-2 can use the different images shown in FIG. 5 for one specific game, or the same deal of a game. In other examples, the different images shown in FIG. 5 can be used with identification panels 50 for varying the front outer sides 30 for the breakopen tickets of FIG. 3A, such as the exterior of the breakopen portion on the plurality of randomized tickets. In further examples, the different images shown in FIG. 5 can be used for varying the images on the breakopen portions 33 that reveal the game play combinations 34. In other examples, the identification images 56 can also further include varying background colors or patterns.

Varying the “common” side of the ticket and/or the window side of the ticket within a game set makes the identification of winners more difficult, if not impossible. Thus, varying the identification panel on any type of ticket can increase the security of the game of chance. A digital printing technique using digital printing machines is used to vary the common side and/or the window portions of the tickets, rather than printing using an offset, flexo, silk screen, or other static processes or combinations of static processes.

In another example, the shapes of the tickets can be different within one deal or game set. For example, a game may be called “Fortune Cookies” with 20 different shaped fortune cookies within the same game set. Traditionally, all tickets within the game set have to be exactly the same shape. Thus, changing the shapes of the tickets can provide additional security to a game. Example ticket shapes can include, ducks, hamburgers, cars, cans, bottles, pickles, and cell phones. In another example, a base silver or a base gold can be applied to a portion of the plurality of randomized tickets. A transparent ink can then be placed on top of the base silver or the base gold. The base silver or base gold can help in creating a metallic effect for a ticket, such as a breakopen gaming ticket.

FIG. 6 shows a third example of a digitally produced ticket. The digital printing of a color area 60 on any visible side of a ticket can be provided to identify the ticket within a game set. The color area 60 can be digitally printed to identify each game set. The color area 60 can be in varying shapes such as quadrilaterals, lines, circles, etc. and can be located on any portion of the ticket. Furthermore, more than one color area 60 can be used, such as providing a line of color on the top and bottom of the ticket. The color area 60 can be used to identify the set of the game in addition to identifying the serial number for the game. FIG. 7 shows an example of a static printed window from a traditional game set. Traditional tickets are statically printed with different color backgrounds 70 or color windows to identify different games that are being played. Some of the benefits of providing the color area 60 are the ability to have the full range of 16 million colors identifying game sets within a master carton or quantity of master cartons without any limitation based on the color of ink on the press. Providing the color area 60 also limits having any additional ink changes.

A method of digitally printing breakopen tickets will now be described that can be used for each of the example tickets. A substrate comprising a roll of paper is pre-printed on an offset web or flexo press, providing a static printing step. At this point, static printing is completed. The substrate is re-wound at the end of the static print step. If desired, the tickets can be completely digitally printed and no portion statically printed.

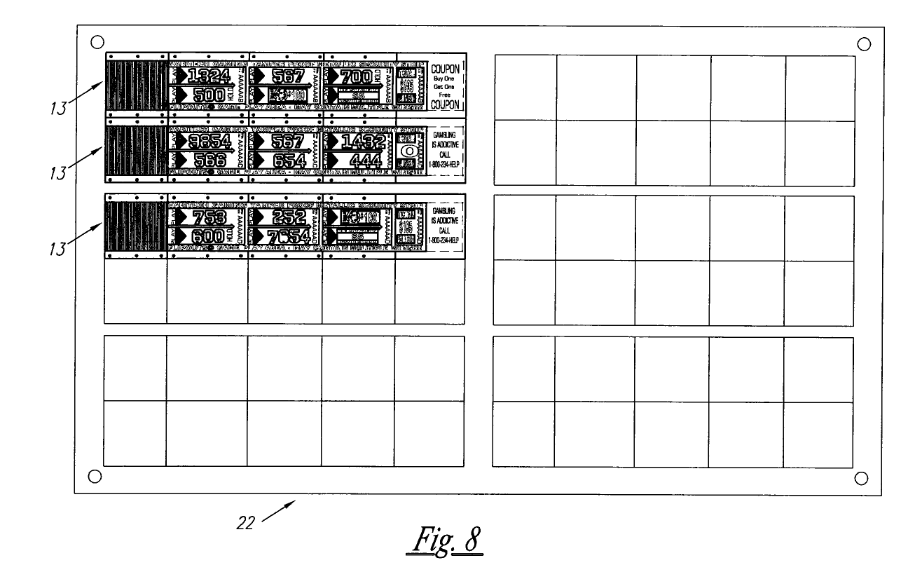

FIG. 8 shows an example of a digital press sheet 22. The example digital press sheet 22 has three tickets 13 but can obviously include any number of tickets. The data used to populate the digital press sheet represents a full game set. The data then provides a collection of viewable digital press sheets that can be viewed using an appropriate software package. The digital press sheets can be viewed electronically and checked/verified prior to printing. In an embodiment, the data is in the form of a PORTABLE DOCUMENT FORMAT (.pdf) file and can be viewed via the ADOBE READER software package. A method for creating digital press sheets will now be described.

A game symbol set is picked from a pre-determined set of ticket symbol sets, or a new set is developed and entered into a database. The game rules are set by the operator of a program for generating digital press sheets, which includes factors such as what constitutes a winning or losing play combination and the number of tickets in a game set. Other rules may include special symbols or number combinations that would be omitted, for example, per a customer request.

The program then goes into a loop that will create one ticket at a time and compare it against the rules that have been set. If the ticket passes the rules test it is stored and the number of needed tickets is decreased by one. If the ticket fails the test it is discarded and a ticket counter does not advance.

Once a game set has been generated, the program creates a random placement list. This is a table of data that reorders the ticket output for subsequent game. This allows for per-ticket tracking for easy reprinting or checking. Each list can be identified by the batch serial number allowing for easy retrieval of the data.

Next the individual tickets are generated and saved in a folder. Each ticket's data is read from the database and the ticket symbols are arranged on the digital press sheet template and saved. These tickets are used in the next phase of the process. Generating tickets in this manner reduces the processing time because the tickets need only be created once.

The process continues with the creation of single or multi page .pdf documents. Each page of the .pdf document contains at least one and preferably contains at least 2 or more tickets. The process is done by loading a placement list and using it to determine the order in which the pre-generated tickets are imposed onto the digital press sheet. The placement and number of tickets placed on the press sheet is determined by a calculation based on the size of the final press sheet and the number of tickets that can fit on the preset size. Each placement list is processed in the same manner thus giving each box of tickets a unique ticket order. In this phase the serial number or alphabetic serial code is applied, the correct serial number is always used because the only number available is the one stored with the placement list.

The .pdf documents are digitally stored as complete press sheets for printing on the digital printer/press. Once the .pdf document is complete, no further randomization of ticket placement on the press sheet occurs. Each digital press sheet can be printed off for final customer approval before the printing process and all approved press sheets can then be printed on the digital printer based on the operator's instructions to download specific sheets to the digital printer. The operator can choose to print a complete multipage file on the printer with a full or partial game set or he/she can choose to print single pages.

Digital press sheets are not limited to any particular file format. All acceptable storage formats including, .pdf, 1 bit tiff, jpg, tif, postscript, ppml, xml, or any other digital formats that can be used to store a set of tickets digitally in a pre-set sequence on a page is included in this method of printing tickets.

It is important to note that the process discussed above for creating digital press sheets does not interact directly with the digital printer and singe tickets are not sent to the printer in random format for population on the Raster Image Processor (RIP) of the digital printer/press. The process creates the final digital press sheet before the data is sent to the RIP allowing for customer verification and approval. Absolutely no variable data is applied to the press sheets after the sheets have been generated.

This system allows for easy duplication of a game set during a subsequent printing. Digital press sheets can eliminate the need for multiple films and plates and press runs. The pre-generation of digital press sheets into multi-page documents will allow for the printing of one set of tickets for review and approval before printing a full game set or printing just the game and advertising information for that set of tickets onto an approval proof sheet for the customer to approve before the job is printed. The use of online digital sign-offs by a customer on complete ticket sets can also be accomplished.

Digital press sheets, in single page or multi-page format, having a ticket or tickets imposed on each sheet can be downloaded to the printer in the page description format of that printer. Example page description formats include postscript, pcl, ppml, xml, and other page description formats used to describe to the digital printer how to image the contents of the data file to the substrate media on which printing is to occur. A digital printer prints the images onto the substrate. The images are represented by digital information or data provided to the digital printer. The data is pre-generated and sent to the digital printer as a data file. The data in the file represents a complete, randomized game of chance set. The printer does not perform a further randomization of the tickets or play combinations. In an embodiment, the data is in the form of the digital press sheets. After images corresponding to the game set are printed onto the substrate, the substrate is re-wound onto a roll at the end of the digital printer. The roll of substrate is then introduced to a finishing line where the substrate is scored along its center, in the direction of the web. A score line can provided along fold line 38 and is used to fold the web of substrate onto itself, as seen in FIG. 3B. Digital press sheets can be provided in other formats, such as bitmapped formats or vector-based formats, for example. In some instances the complete ticket will be digitally printed including all information included on both sides of the ticket, and no portion of the ticket will be printed statically.

Breakopen portions 33 are diecut into rear outer side 31 of the web of substrate. Cutting the breakopen portions 33 may occur at the time of scoring the substrate along its center. Glue is then pattern applied to rear inner side 36 of the substrate to areas that surround the breakopen portions 33. The glue is applied so as to avoid the breakopen portions 33, allowing the breakopen windows 33 to be pulled open.

The web enters a plow fold, which folds the left side of the web onto the right side of the web along scored fold line 38. It then passes through two nipper rollers that press the two sides of the single substrate and seals them together. The substrate has been folded to form a first ply and a second ply and the web is half its original width.

If desired, a decorative die can be introduced for specially shaped tickets. The die would cut through the laminated substrate leaving nicks to hold the tickets in place. Laser cutting devices, such as laser die cutters could be used to cut the windows 33 and the decoratively shaped tickets.

The folded and glued web then passes through a slitter that slits the folded and glued web into ribbons of tickets. The ribbons of tickets are then cross cut using a sheeter into single tickets and delivered shingled on a conveyor. Alternatively the sheeter can sheet the tickets into sheets of tickets that can then be placed on a guillotine cutter to cut them into individual tickets.

Lenticular screens are lenses that have varied angles within them that, when placed upon a printed image, create the illusion of movement. Lenticular screens can be included in a breakopen ticket to create the illusion of movement of the images on the ticket. Such an effect is produced by printing images on top of each other and then applying a lenticular lens, with each angle on the lens showing one of the images to which it is applied. Lenticular screens can be used to create multiple game plays in a single area, wherein viewing the area from different angles reveals different play combinations.

The printing of a data file discussed above differs from a variable print process in that variable printing requires a database that is accessible by a printer at the time of printing. Population of a game ticket with various play combinations happens at the time of actual printing via the printer's accessing of the database, so customer pre-approval of a game set cannot be achieved. Database errors can occur and an incorrect ticket set can be produced and sealed with no digital verification. Digital construction of press sheets into multi-page files ensures that all game sets can be checked and approved before the digital press is used to apply the data. The digital press sheets can be used with any of the example tickets and methods discussed throughout this disclosure.

In one embodiment of FIG. 8, a set of tickets can be digitally divided into groups of relatively equal sizes and digitally distributed. The method can include the step of providing data that includes the randomized tickets where the data includes the play combination area and a customized payout scheme defining a number of winners for a specified amount of randomized tickets. The method can further include digitally dividing the data into groups of relatively equal sizes wherein approximately equal payout values are provided within the plurality of randomized tickets of each group. The method can also include the step of forming at least one digital press sheet from the groups of data that include the plurality of randomized tickets and the play combination area. The user can customize the payout scheme, the group sizes, and the number and amount of winnings in each group. Approximately equal payout values can be provided within the randomized tickets of each group, or quadrant, specified within the set of tickets. Thus, the data in FIG. 8 can be manipulated to populate individual tickets onto specific pages or quadrants so that each stack of pages has approximately equal payout values. Moreover, the digital press sheet can be used to control the randomization, such as the distribution of various types of winners, within a specific group. Thus, if one group of tickets is going to a specific store, hall, or other location, the randomization of winning tickets can be controlled within the group to prevent situations where all of the winning tickets are remaining at the end of the set. Furthermore, the randomization can be controlled so that if the odds of winning something are supposed to be 1 in 5, the group of tickets can even mirror the odds. This does not necessarily require that there be one winning ticket placed after every four losing tickets in the group but it can prevent situations where a longer series of losing tickets are placed together in the group. Thus, this method can exert a tighter control on the distribution of winners within a group and can also allow an operator to specify the exact randomness and distribution of tickets within a set or within groups of a set.

Another example of the subject invention, in FIG. 9, is a fourth example game ticket or card for a lottery game that can be printed digitally such as with the digital press sheet of FIG. 8. The ticket of FIG. 9 includes a front side portion 90, a rear side portion 92, a left inner side portion 94 and a right inner side portion 96. The front side portion 90 and the rear side portion 92 are printed on one side of a piece of stock, such as a piece of cardboard or paper. The left inner side portion 94 and the right inner side portion 96 are printed on the other side of the piece of stock. The stock is folded to form the game ticket such that the front side portion 90 and the rear side portion 92 are visible, while the left inner side portion 94 and the right inner side portion 96 are folded over each other and hidden. The ticket may be sealed in the folded position, for example by gluing. Prior to playing the game, the seal is broken and the ticket unfolded to reveal the hidden left inner side 94 and right inner side 96 portions.

The front side portion 90 can be an identification panel 50, such as shown in FIG. 5. The front side portion 90 can further include game-identifying indicia, such as a game title 52 and an identification image 56. The identification panel 50 can be varied within the game, as described in relation to FIG. 5. The front side portion 90 in this example of FIG. 9 can include a game serial number 97, which identifies a particular “deal” of the game, and a card number 98, which identifies a particular card of the particular deal. The locations of the game title 52, the identification image 56, the serial number 97, and the card number 98, can be varied throughout the front side portion 90.

The rear side portion 92 includes game payout information. The game disclosed herein is a bingo game. The rear side portion 92 shows various configurations of bingo number matches, for example matches forming an “+” or “x” configuration, and their associated payouts. The rear side portion 92 further shows the number of winners for the particular deal. In the example of FIG. 9, there are a quantity of 4 $100 winners, 8 $50 winners, 10 $25 winners, 50 $5 winners and 100 $2 winners for the particular deal. It is possible for a particular card to have multiple winners. For example, a particular card could provide both a $5 winner and a $2 by having bingo number matches that form both a “+” and an “×.”

The game of FIG. 9 is an example of how the game's merchant can choose the number of cards in the deal and a customized payout scheme, such as the number of winning cards, payout amounts, winning configurations, etc. The customized payout scheme can define the number of winners for a specified amount of randomized tickets, such as the entire deal of a game or even for specific groups within the deal of a game. A computer program randomly generates the deal based on the merchant's specifications and can print the game set onto a substrate using digital printing techniques. The data can first be formed on at least one digital press sheet and then printed onto a substrate. The rear side portion 92 can include one or more of a game form number, game serial number or a card number for verification purposes.

The ticket of FIG. 9 can include a first portion of the ticket and can include a plurality of winning symbols. A second portion of the ticket can include a plurality of game symbols or other game instructions. The plurality of winning symbols can be configured to be compared to the plurality of game symbols to determine if a specific ticket is a winner. It is appreciated that a first portion and a second portion of the ticket can be on the left inner side portion 94 or on the right inner side portion 96. It is also appreciated that a first portion and a second portion can be on other portions of the tickets. A bingo game, in one example, can be played by first opening the game card to reveal a plurality of game symbols, such as pre-called bingo numbers, on the left inner side portion 94 and a player's card on the right inner side portion 96. The player compares the pre-called bingo numbers to the numbers on the player's card, to determine if the player has obtained any bingo number matches between the pre-called numbers and the plurality of winning symbols on the player's card. The player can mark any bingo number matches with, for example, an ink dauber, to assist the player in determining the match configuration for that card. If the match configuration is a winner, as shown on the rear side portion 92 of the card, the player is awarded the corresponding prize or prizes. For example, if the match configuration of the bingo number matches forms a “+”, then the player is awarded $5. If the match configuration forms an “x”, then the player is awarded $2. In other examples, symbols other than numbers can be used.

The left and right inner side portions 94, 96 can include one or more of the game form number, game serial number and card number printed thereon. In an embodiment, the pre-called bingo numbers on the left inner side portion 94 are concealed underneath scratch-off ink, foil, or perforated tabs. The scratch-off ink, foil, or perforated tabs are removed by the player to reveal the pre-called bingo numbers, which are then compared to the numbers on the player's card located on the right inner side portion 96. In one example, the ticket of FIG. 9 is part of a breakopen ticket such as a substrate that is folded to form a first ply and a second ply. In another example, the left inner side portion 94 can also include a breakopen structure.

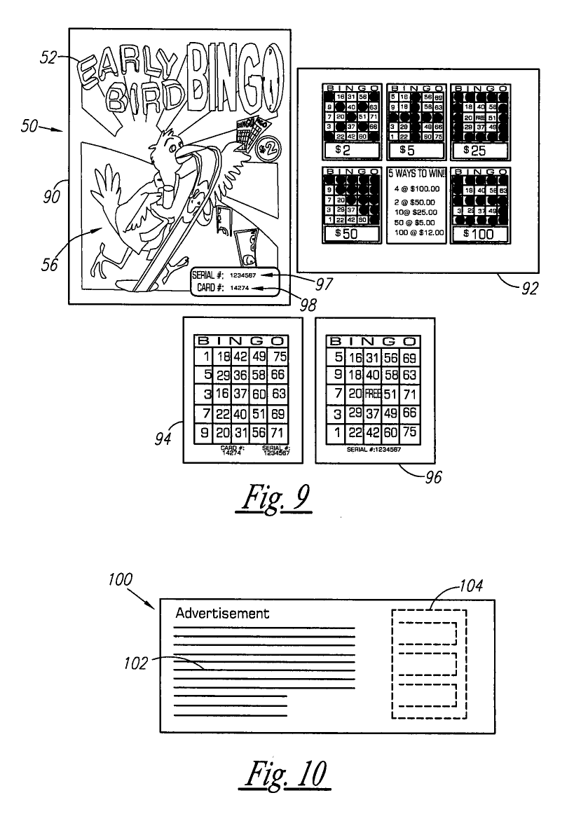

Another example of the subject invention can be seen in FIG. 10. FIG. 10 shows a portion of a fifth example ticket that can be an advertising piece 100 that can include a card that contains information 102 such as advertising, product information, etc. on the face and on the back side. The advertising piece 100 also includes a detachable ticket 104 that can be “pushed out” or torn off of the advertising piece and used as a redeemable coupon or discount qualifier, or instant win of a product or a service, etc. at the place of the advertiser. The detachable ticket 104 can also include a breakopen portion. An example is a mailer sent out in a geographical area advertising a food establishment. Receivers of the card would read the card for the offer then punch the breakopen out of the card by breaking it at the perforations and the keep the breakopen ticket to be used for an instant win or additional offer or discount at a later date at the advertiser's food establishment. Coupons in the form of instant give away products would add value to the purchaser but have no additional cost to the ticket. The advertiser promotes their product and the purchaser of the ticket has the opportunity to redeem the product. An example may be for a soda company to provide 100 cases of soda redeemable through games of chance tickets sold and purchased with a guaranteed sale price and payout price. The additional wins of cases of soda could be included as instant wins throughout a game set or multiple game sets either locally or over a geographical area. The soda company gets product advertising, seller provides increased value to customer, and customer has additional opportunity to win.

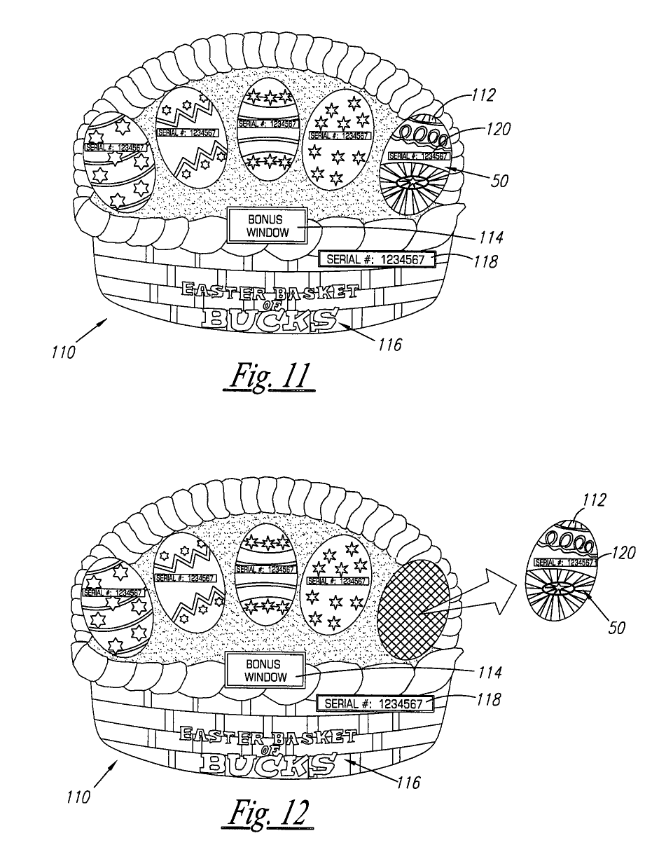

The example of FIG. 11 shows another aspect of the subject invention. FIG. 11 includes a host structure 110, which is depicted as a basket in this example, which holds a plurality of sixth example removable tickets 112. FIG. 11 shows a multi-play breakopen host structure 110 that can hold one or a plurality of tickets. The removable tickets 112 for each host structure 110 can be part of the same deal, meaning that they can be part of the same game. It is appreciated that a plurality of host structures can be used for any one deal of a game. The plurality of host structures can also be configured to hold different amounts of tickets 112 to provide additional options to a purchaser, though in this example, five removable tickets 112 are provided. For example, the plurality of host structure can each hold at least five removable randomized tickets.

In this example, the host structure 110 includes a game title 116 which can also include varying graphics. The host structure 110 can also include a serial number portion 118. The host structure 110 can further include varying graphics. The tickets 112 can include a serial number portion 120 that corresponds to the serial number 118 on the host structure 110. The tickets 112 can also each include varying graphics, symbols, or text on an identification panel 50 of the ticket 112. The identification panel 50 in FIG. 11 can be the entire visible portion of the ticket 112 that is shaped like an egg.

FIG. 12 is an example of one of the randomized tickets 112 being removed from the host structure 110. The shape of the randomized ticket 112 can be detached from the host structure 110. In other examples, a shape bigger than the shape of the ticket 112 can be removed. In an example of use, the host structure 110 can be purchased from the store for the price of five tickets 112. The user can then choose which tickets 112 to remove and in which order. The tickets 112 can be from the same deal from the same game. It is also appreciated that the host structure 110 and the randomized tickets 112 can be prepared using a digital press sheet, as in other examples of the subject invention.

The host structure 110 can further include a seal card 114 which can be hidden by additional breakopen window, or windows, or scratch-off coating or other hiding device. The seal card 114 can be located on the host structure 110 and is configured to reveal at least one payout scenario for the removable randomized tickets 112 from each host structure 110. The scenario can be a list of symbols that can be found on a ticket 112. The scenario can be a bonus prize or a “qualifier” that links to the removable tickets 112 or the payout scenario can be a possible payout for the removable tickets 112. The seal card 114 can have unique scenarios specific to the deal of the game or that are only available for the number of removable randomized tickets 112 that are included within that host structure 110. Thus, the seal card 114 can be the same within a deal of a game for each host structure 110 or the seal cards 114 can be varied within each host structure 110 for a deal of a game. The plurality of removable randomized tickets 112 can each include one or more breakopen portions or windows.

The plurality of tickets in this example is in the shape of an egg and the entire host structure 110 and tickets 112 can be digitally printed. Each ticket 112 that is shaped like an egg can be removed from the host structure 110 but each ticket 112 can contain the same serial number as the host structure 110. In other examples, the tickets 112 can be objects other than eggs such as an ornament, a flower, or other representations of pieces of food. In further examples, the plurality of host structure can be in the shape of objects other than baskets, such a tree, a genie's bottle, a vase, or various representations of structures that support pieces of food. The host structure 110 is an object that a user purchases and takes with him.

After each ticket 112 is removed it can be played like a regular game to attempt to win a payout. However, the ticket 112 can also include symbols corresponding to the scenario shown on the seal card 114. State and provincial laws dictate exact payouts that must be given within a game set. For example, a game set of 1000, one dollar tickets takes in $1000.00. The guaranteed payout may be $500.00, giving the operator a guaranteed $500.00 profit and the buyers the guaranteed chance of $500.00 in prizes. The tickets 112 can further participate in a possible payout located on a seal card 114 found on the host structure 110. A possible payout feature can make use of digital printing to add an additional “value” that may be monetary prizes or products and services that carry a value. Thus, the seal card 114 can be a bonus window where the tickets 112 have a guaranteed payout, such as 70%, and a possible payout only possibly occurs which, in one example, can increase the total payout from 70% to 75%.

The possible payout is paid for each ticket 112 that includes one of the scenarios described in the seal card 114. For example, in a game called BIG THREE BONUS, if a player obtains three predefined tickets, such as ticket numbers 0123, 0234 and 0456 from a game set, the player receives a bonus prize. The bonus is a Possible Payout, because no individual player may actually obtain all of the three predefined tickets. The predefined set of circumstances that allow the bonus prize may be concealed in the seal card. The Possible Payout game complies with minimum payout requirements dictated by law, and allows for an additional payout beyond the minimum.

In another example of a method of preparing a possible payout for a game of chance, a customized guaranteed payout scheme can be used for the set of the plurality of tickets. Data can be provided to a printer where the data includes a digital press sheet that includes the plurality of randomized tickets and the play combination area. The data can further include the customized guaranteed payout scheme to define the number of winners for a specified amount of the randomized tickets. A plurality of winning symbols can be printed in the play combination area on a first portion of each of the randomized tickets where the plurality of winning symbols are configured to determine if a specific ticket is a winner. At least one additional payout scenario can be printed either on the ticket, on an existing flare card, on a seal card, or in another location accessible to a player, such as the internet. A possible payout, which can increase the winnings of a game, is paid for each ticket that includes the additional payout scenario. If a seal card is provided, the possible payout is paid for each ticket that includes the scenario on the seal card. It is appreciated that the possible payout for a game of chance is not limited to use with a host structure.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A method for printing a plurality of randomized tickets that include a play combination area for a game of chance, comprising the steps of:
providing data to a printer, wherein the data includes a digital press sheet that includes the plurality of randomized tickets, wherein each randomized ticket includes an identification image; wherein the digital press sheet includes a plurality of different identification images;
printing the digital press sheet onto a substrate; and
further wherein the printer does not perform a further randomization of the plurality of randomized tickets.

2. The method of claim 1, wherein the plurality of different identification images are located on an outer surface of a breakopen portion on the plurality of randomized tickets.

3. The method of claim 1, further comprising the step of providing a color area digitally printed on a portion of each ticket to identify each game set.

4. The method of claim 1, further comprising the step of applying an ultraviolet coating over the top of the play combination area of the plurality of randomized tickets.

5. The method of claim 1, further comprising the step of applying glitter mixed with an ultraviolet coating to create a sparkling coating on desired areas of the plurality of randomized tickets.

6. The method of claim 1, further comprising the step of applying a base silver or a base gold on a portion of the plurality of randomized tickets; and applying a transparent ink on top of the base silver or the base gold to create a metallic effect.

7. A method for printing a plurality of randomized tickets that include a play combination area for a game of chance, comprising the steps of:
providing a breakopen portion, having an outer surface and an inner surface, on one of a first ply and a second ply for revealing a play combination, wherein the play combination is printed on one of the first ply and the second ply by a printer based on data that includes the plurality of randomized tickets, and wherein the printer does not perform a further randomization of the plurality of tickets;
printing a blockout area on the outer surface of the breakopen portion; wherein the blockout area is configured to meet or exceed a predetermined opacity; and
printing said play combination on the inner surface of the breakopen portion.

8. The method according to claim 7, wherein the blockout area includes at least one ultraviolet ink, water-base ink, or solvent base ink.

9. The method according to claim 7, further comprising the step of printing a serial number on a portion of the inner surface of the breakopen portion.

10. A method for providing a plurality of randomized tickets that include a play combination area for a game of chance, comprising the steps of:
providing data that includes the plurality of randomized tickets, wherein the data includes the play combination area and a customized payout scheme defining a number of winners for a specified amount of randomized tickets;
digitally dividing the data into groups of relatively equal sizes wherein approximately equal payout values are provided within the plurality of randomized tickets of each group; and
forming at least one digital press sheet from the groups of data that include the plurality of randomized tickets and the play combination area.

11. The method of claim 10 further comprising the step of controlling a distribution of winners within a group.

12. A method for printing a plurality of randomized tickets that include a play combination area for a game of chance, comprising the steps of:
providing data that includes the play combination area and a customized payout scheme defining a number of winners for a specified amount of randomized tickets to form the plurality of randomized tickets on at least one digital press sheet;
printing the at least one digital press sheet onto a substrate;
printing a plurality of winning symbols in the play combination area on a first portion of each of the plurality of randomized tickets;
printing a plurality of game symbols on each of the plurality of randomized tickets on a second portion wherein the plurality of winning symbols are configured to be compared to the plurality of game symbols to determine if a specific ticket is a winner;
printing at least one of a game form number, game serial number, or a card number on the plurality of randomized tickets for verification purposes; and
folding the substrate to form a first ply and a second ply.

13. The method according to claim 12, wherein the plurality of winning symbols are concealed underneath at least one of a scratch-off ink, a foil, or a perforated tab.

14. A set of a plurality of tickets for a game of chance, comprising:
a plurality of host structures;
a plurality of removable randomized tickets located on each of the plurality of host structures wherein the plurality of removable randomized tickets include a play combination area;
a seal card located on each of the plurality of host structures that is configured to reveal a payout scenario for the plurality of removable randomized tickets;
wherein the plurality of removable randomized tickets each include one or more breakopen portions or windows.

15. The game of chance of claim 14, wherein the plurality of host structures each holds at least five removable randomized tickets that are in a shape of one of the following: an egg, an ornament, or a flower.

16. The game of chance of claim 14, wherein the plurality of host structures are in a shape of one of the following: a basket, a tree, or a vase.

17. A method for printing a plurality of randomized tickets that include a play combination area for a game of chance, comprising the steps of:
providing a customized guaranteed payout scheme for the set of the plurality of tickets wherein the customized guaranteed payout scheme defines a number of winners for a specified amount of randomized tickets;
providing data that includes the play combination area, the customized guaranteed payout scheme, and at least one additional payout scenario, to form the plurality of randomized tickets on at least one digital press sheet;
printing the at least one digital press sheet onto a substrate;
printing a plurality of winning symbols in the play combination area on a first portion of each of the plurality of randomized tickets wherein the plurality of winning symbols are configured to determine if a specific ticket is a winner; and
providing a possible payout that is paid for each of the plurality of tickets that includes the at least one additional payout scenario.

18. The method of claim 17 further comprising the step of providing a seal card for the game of chance that includes the at least one additional payout scenario.

19. The method of claim 17 further comprising a section that includes an instant win of a product or a service from an advertiser.

20. The method of claim 19 wherein the instant win is detachable from each of the plurality of tickets.
